(19) United States
(12) Patent Application Publication
(10) Pub. No.: US 2002/0016173 A1
(43) Pub. Date: Feb. 7, 2002

(54) Communication of location information in a wireless communication system

(76) Inventor: Jason F. Hunzinger, Carlsbad, CA (US)

Correspondence Address: SCOTT C. HARRIS, Fish & Richardson P.C., Suite 500, 4350 La Jolla Village Drive, San Diego, CA, 92122, US

(21) Appl. No.: 09/885,436

(22) Filed: Jun. 18, 2001

Related U.S. Application Data
(60) Provisional application No. 60/213,213, filed on Jun. 21, 2000.

(51) Int. Cl. H04Q 7/20

(52) U.S. Cl. 455/456; 455/466; 455/525

(57) ABSTRACT

A mobile station, such as a cellular or PCS phone, in a wireless communication system transmits position information to the system server. The mobile station may communicate position location and movement tracking information between the mobile station and the wireless communication infrastructure.

### CROSS-REFERENCE TO RELATED APPLICATIONS

This application claims benefit of U.S. Provisional application No. 60/213,213, filed Jun. 21, 2000.

### TECHNICAL FIELD

This invention relates to wireless communication systems, and more particularly to enhanced handoff control within wireless communication systems.

### BACKGROUND

The present invention communicates position location and movement tracking information between a mobile station, such as a cellular or Personal Communication Services (PCS) phone, and a wireless communication infrastructure. In particular, implementation of the present invention as an extension and modification of methods, data structures, and hardware structures for message transfer, as described by the Wireless Application Protocol Wireless Telephony Application Interface Specification, WAP WTAI (GSM), WAP-171-WTAIGSM, Version 07-Jul-2000, published by the Wireless Application Protocol Forum, Ltd., herein incorporated by reference, and used with a code division multiple access (CDMA) wireless communication system, is a preferred embodiment. Said CDMA wireless communication system is fully described by the following standards, all or which are published by the TELECOMMUNICATIONS INDUSTRY ASSOCIATION, Standards & Technology Department, 2500 Wilson Blvd., Arlington, Va. 22201, and all of which are herein incorporated by reference: TIA/EIA-95B, published Feb. 1, 1999; TIA/EIA/IS-2000,1-A, published Mar. 1, 2000; TIA/EIA/IS-707, published February 1998;TIA/EIA/IS-707-A, Published March, 1999, TIA/EIA/IS-707-A-1, published December, 1999; and, TIA/EIA/IS-707-A-2, published June, 2000. The further implementation of this invention with other messaging protocols and data structures and wireless communication systems is straightforward to one skilled in the art.

### SUMMARY

A system for communicating information related to the position of a mobile station within a wireless communication infrastructure, comprising: a mobile station capable of transmitting and receiving signals to and from a wireless communication infrastructure using code division multiple access techniques; a wireless communication infrastructure that can transmit and receive signals to and from a mobile station using code division multiple access techniques; and a data server capable of communicating with said wireless communication infrastructure; wherein said mobile station and said data server communicate via said wireless communication infrastructure using formatted messages representing wireless communication infrastructure state information related to said mobile station's position within the service area of said wireless communication infrastructure.

### DESCRIPTION OF DRAWINGS

These and other features and advantages of the invention will become more apparent upon reading the following detailed description and upon reference to the accompanying drawings.

FIG. 1 is a diagram of a roving mobile communication terminal moving amongst different locations between sectors in a wireless communication system.

FIG. 2 depicts a wireless communication infrastructure interposed between a roving mobile terminal and a data server.

FIG. 3 is a protocol layer diagram of a mobile station, an optional Wireless Application Protocol (WAP) gateway, and a data server.

FIG. 4 is a system architecture diagram of functions and components of the mobile station and server that relate to the new invention.

### DETAILED DESCRIPTION

The present invention comprises methods, data structures, and apparatus for enabling communication, via a wireless infrastructure, of information that is incidental to the operation of a mobile station (MS) within the wireless infrastructure, said information being useful for estimating the location of said mobile station for local, remote, or distributed services based upon the mobile station location that may reside locally at the mobile station, remotely, at a remote data server, or jointly between a mobile station and a remote data server. Examples of such services based upon a mobile station location include local weather reports, finding the nearest service station, restaurant, etc. Similarly, such mobile station location information can be stored, over time, either locally at the mobile station, remotely at the data server, or jointly between a mobile station and a remote data server, and used to extrapolate the movement, or trajectory, of a roving mobile station.

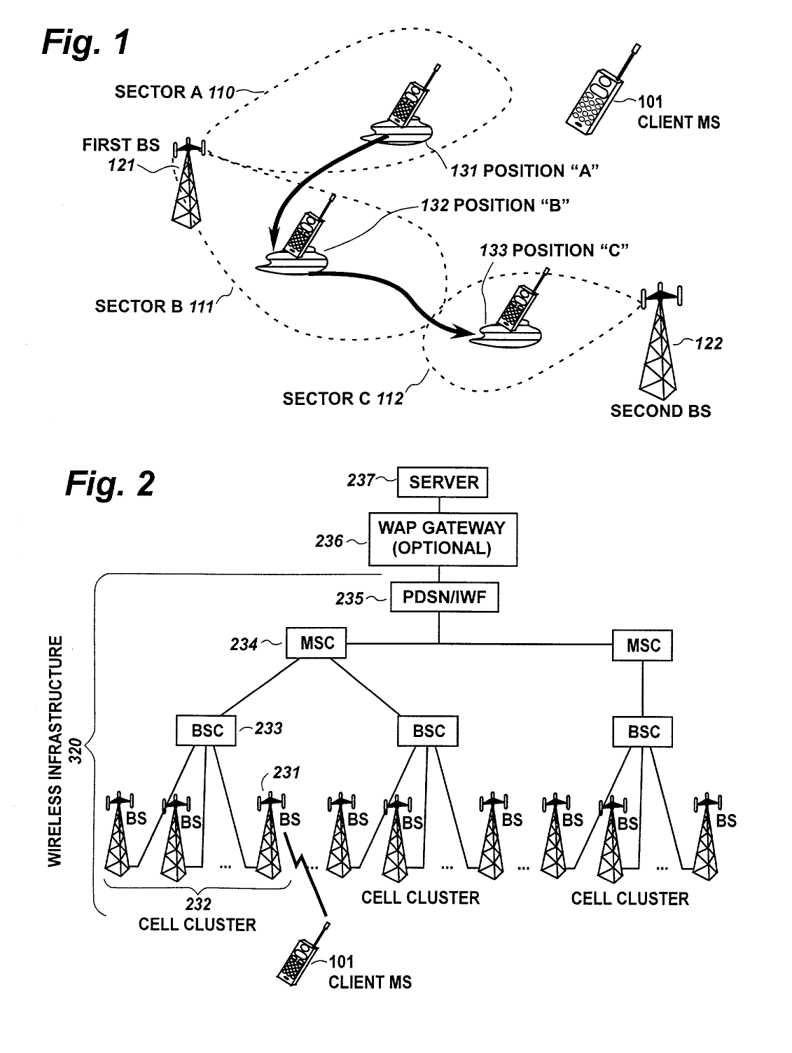

FIG. 1 depicts an example of a mobile station 101 that roves through a geographic area served by a wireless infrastructure including a first base station (BS) 121 with wireless sectors A 110 and sector B 111, and a second BS 122, with a sector C 112. In the course of such roving, mobile station 101 travels from position A 131 to position B 132 to position C 133, and as a matter of course, experiences a number of wireless communication infrastructure context states, and state transitions, hereafter referred to as “network contexts”. One way of specifying network context is a set of System Identification (SID), Network Identification (NID), Base Station Identification (BS_ID), and Sector Pseudo-Noise offset (PN). Consider that the base stations and sectors in FIG. 1 have the same SID and NID. The BS_ID and PN that the mobile station 101 is monitoring identify the different positions of the mobile station 101. For example, a mobile station that is monitoring the first base station 121 and sector A 110 is likely to be in the area defined by the dotted line of Sector A 110, such as the position “A” 131. Such network parameters can be used to differentiate mobile station different positions such as from Position “B” 132 and Position “C” 133. By retaining past positions of a roving mobile station, it is possible to determine the position track that the rover has followed over time, and to extrapolate a future position. The extrapolation of the future position may be done on the basis of a simple, linear, trajectory calculation, or the extrapolation may be further modified by prior knowledge, stored in a data server, of geographic or topographical constraints on the rover's trajectory.

FIG. 2 depicts a generic structure of a wireless infrastructure 320. A client mobile station's (MS's) 101 general location may be estimated by reporting the base station sector, base station 231, or other network context information, through a base station controller (BSC) 233 that may control a cell cluster 232, through a mobile switching center (MSC) 234, through a Packet Data Switching Network (PDSN) or Inter-working Function (IWF) 235, and through an optional WAP gateway 236, to a data server 237. The data server 237 is capable of converting the base station sector, base station, or other network context information to a geographic location estimate of mobile station 101. Such a location estimate may be in terms of latitude or longitude, or in terms of geographic sectors defined on the basis of other factors such as known shopping center areas, industrial campus areas, transportation terminal facilities, or similar areas of grouped activities or interests. Such an estimated location of the mobile station 101 can also be correlated with information stored in a database addressable by a server 237 that contains information relevant to the mobile station 101 at that mobile station's particular estimated location.

Furthermore, if multiple, sequential location estimates of the mobile station 101 have been determined, an estimate of the trajectory of motion for the mobile station can also be determined, using well-known extrapolation techniques, possible constrained with known geographic or topographical constraint information. This will further allow correlation of the mobile station's estimated position and estimated trajectory with information stored in a database addressable by the server 237 that responds with information relevant to a mobile station at that particular mobile station's estimated location, and on that particular mobile station's estimated trajectory.

Alternately, a mobile station 101 may monitor the network context or be updated by the bearer service of events that change the current network parameters such as communicated by cell-to-cell, cell sector-to-cell sector, or wireless system-to-wireless system handoff message from the infrastructure. Such information can be stored within the mobile station 101. Additionally, the mobile station 101 may store a sequential record of such information providing the basis for position estimation and trajectory estimation, as previously discussed. Such information may then be later conveyed to a server 237, as described above, if and when requested by the server 237, or if and when desired by the mobile station 101 or mobile station operator.

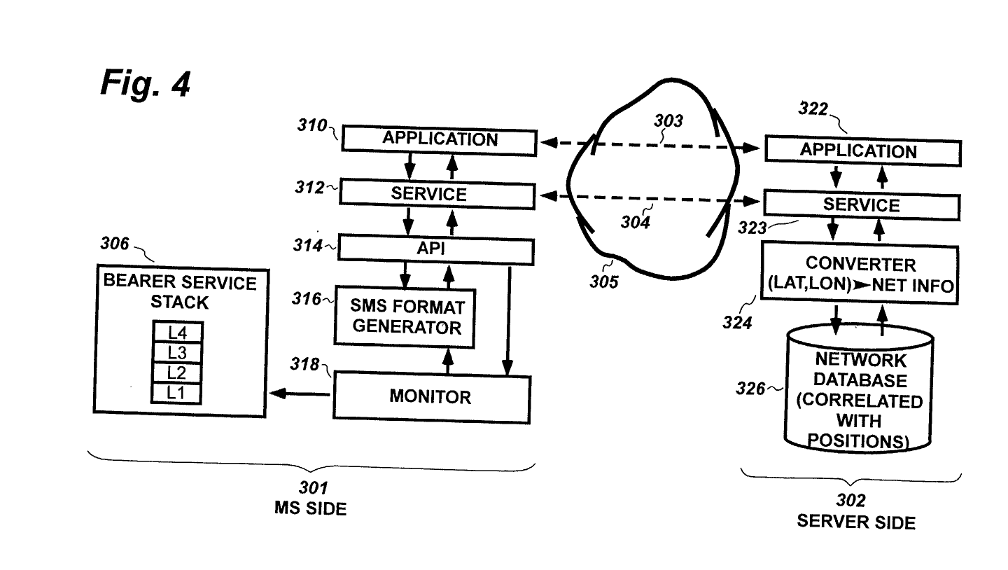

FIG. 4 shows an aspect of location-related components embodied within the mobile station side 301 and server side 302. The mobile station 101 may estimate location or trajectory based on such network information or subsets of this network information to applications 310 or services 312 that reside within the mobile station 101, or to application 322 or service 232 residing on a remote server 237. The location or trajectory information can be provided to the remote server side 302 via mobile originated Short-Message-Service (SMS) or browser calls (packet or circuit switched data). The mobile station 101 may communicate such information to a local application or service such as Wireless Markup Language Script (WMLScript) via a Wireless Application Protocol (WAP) Wireless Telephony Application Interface (WTAI) extension or to a local or custom handset application via internal function calls or messaging such as through an Application Programming Interface 314. A mobile station may provide such location information to a remote service that is enabling a remote application directly by a service-to-service interface 304 or applications may communicate such information amongst themselves by a direct application-to-application interface 303.

This invention teaches methods, apparatus, and data structures for mobile stations to provide such location-based services with location context information in a standardized format.

The information can be exchanged in the form of a string (ASCII text string) or equivalent binary format. The string or set of octal fields consists of one or more location records each consisting of several fields.

Table 1 shows a standard string or octal/binary format for the network information. This format is such that the most critical information is provided first/earliest in case that some information relating to past mobile station positions needs to be truncated owing to data storage limitations.

TABLE 1
Header Format

| | | |
|---|---|---|
| NO_REC | Number of | (1 or more |
| | Location | depending on |
| | Records | maximum string |
| | | size) |

Followed by NO_REC occurrences of the following:

| | Marker | ‘@’ |
|---|---|---|
| LOC_TYPE | Location | See Table 1. |
| | Information | |
| | Type | |
| LOC_TIME_STAMP | Time Stamp | Time stamp if |
| | | available or |
| | | omitted. |
| LOC_REC | Location | See record |
| | Information | description |
| | Record | according to |
| | | LOC_TYPE. |

The time stamp (LOC_TIME_STAMP) may be:

1) Omitted if unavailable or deemed unnecessary.

2) Absolute in the format “hh:mm:ss.ms” or other standard format

3) Relative in the format “hh:mm:ss.ms” or other standard format

The standard format for CDMA records is specified below in Table 2. All fields shall be separated by a comma, i.e. unless otherwise stated.

TABLE 2
ODMA Record Format

| | | |
|---|---|---|
| MCC | Mobile Country | Value or blank |
| | Code | if unknown |
| UZID | User Zone ID | Value or blank |
| | | if unknown |
| REG_ZONE | Registration | Value or blank |
| | Zone ID | if unknown |
| SID | System ID | Value |
| NID | Network ID | Value |
| CDMA_CH | CDMA Channel | Value |
| OFFSET_RES | PN Offset | See Table 2. |
| | Resolution | |
| RSSI | Received | Value (-ve dBs |
| | Signal | rounded to |
| | Strength | integer) |
| TX_PWR | Transmit Power. | Value |
| D_INCL | Dynamics Info | Y (if included), |
| | Included | blank if not |

Followed by the fields below if D_INCL is set to “Y”.
Each field is followed by “,”.

| | | |
|---|---|---|
| P_SID | Previous SID | Value |
| P_NID | Previous NID | Value |
| P_CDMA_CH | Previous COMA | Value |
| | Channel | |
| TIME_CONSTANT | Time constant | Value followed |
| | for dynamics | directly by |
| | | units (See Table |
| | | 3) |

Followed by the mandatory field(s) below.

| | Marker Text | “BS” |
|---|---|---|
| NO_BS | Number of Base | Integer (0 to |
| | Station | MAX_NO_BS) |
| | records | |
| | Marker Text | “:” |

Followed by NO_BS occurrences of the fields below. The BS_REC and BS_D_REC blocks shall be ordered in decreasing order of sector signal quality. Given limited space, sectors with the worst signal strength shall be omitted.

| | | |
|---|---|---|
| BS_REC(i) | Base | See BS_REC |
| | Station/Sector | description |
| | i's basic | |
| | record | |
| BS_D_REC(i) | Base | Omitted unless |
| | Station/Sector | D_INCL is set to |
| | i's dynamics | See below. |
| | record | |
| | Marker | “;” |

The format of each BS_REC(i) block is as follows. Each field, except the last in the block, shall be followed by a “,”.

| | | |
|---|---|---|
| BS_ID(i) | Base Station | Value or blank |
| | i's ID | if unknown |
| BS_LAT(i) | Base Station | Value or blank |
| | i's Latitude | if unknown |
| BS_LON(i) | Base Station | Value or blank |
| | i's Longitude | if unknown |
| PILOT_PN(i) | Sector i's | Value |
| | Pilot PN value | |
| ECIO(I) | Sector i's | −½dB value |
| | measured pilot | (rounded to |
| | Ec/Io | integer) |
| PN_OFFSET(i) | Sector i's PN | Value in units |
| | offset | of OFFSET_RES |
| | relative to | (blank if |
| | reference | reference or |
| | Sector's PN | zero) |
| | offset | |
| STATUS(i) | Sector's | See Table 4. |
| | status | |

The format of each BS_D_REC(i) block is as follows. Each field, except the last in the block, shall be followed by a “,”.

| | Marker | “:” |
|---|---|---|
| P_STATUS(i) | Sector i's | See Table 4. |
| | previous | |
| | status | |
| D_ECIO(i) | Sector i's | Value in units |
| | Ec/Io | of −½dBs |
| | derivative | (rounded to |
| | | integer) |
| D_OFFSET(i) | Sector i's | Value in units |
| | offset | of OFFSET_RES |
| | derivative. | (blank if zero) |

Table 3 shows the valid values for PN offset resolutions. Table 4 shows valid values for time constant (TIME_CONSTANT) units indicator. Table 4 shows valid values for sector pilots in terms of link maintenance.

TABLE 3
OFFSET_RES Values

| Offset | |
|---|---|
| Resolution | Field Text |
| 1 chip | 1 |
| ½ chip | 2 |
| ¼ chip | 4 |
| ⅛ chip | 8 |
| 1/16 chip | 16 |
| Etc. | Etc. |

TABLE 4
TIME_CONSTANT Units Indicator

| Time Constant | |
|---|---|
| Units | Field Text |
| Milliseconds | “ms” |
| Seconds | “s” |
| Minutes | “m” |
| Hours | “h” |
| Reserved | Reserved |

TABLE 5
STATUS and P_STATUS Values

| Status | Field Text |
|---|---|
| Active Set Pilot | A |
| Desired (Candidate | D |
| or Neighbor being | |
| considered for | |
| handoff) | |
| Neighbor | N |
| Remaining Set Pilot | R |
| Candidate Frequency | C |
| Pilot | |

Table 6 lists the value LOC_TYPE values for location record type. The standard is designed to be compatible with existing GSM WAP based standards for location information.

TABLE 6
LOC_TYPE Values

| Location Type | Field Text |
|---|---|
| CDMA (IS-95A/B, IS-2000, | “C” |
| J-STD-008, etc) | |
| WGS-84 (GPS | “1” |
| coordinates) | |
| GPS | TBD |
| GSM | “3” (see |
| | APPENDIX) |
| Reserved | Reserved |

An alternative to using a custom format for some of the location related network information is to use IS-2000 pilot strength measurement message formats (For example: Pilot Strength Measurement Message (PSMM) or Mini-Message (PSMMM)).

The mobile station 101 provides access to the location related information through a WAP Wireless Telephony Application interface (WTAI) or through a function accessible by browser scripts (WMLScript for example) or other programs. The interface application programming interface (API) 314 can also support specifying the maximum size or length of information that may be returned. For example, if the information is returned as an ASCII string for providing the result as a Uniform Resource Locator (URL) post, then only a limited string length can be used. The mobile station 101 may use this restriction to select the most applicable information that can fit in the desired size. Additionally, the API 314 may allow the caller to select alert-type feedback when a location or network condition occurs such as a handoff between sector B 111 and sector C 112 exhibited in FIG. 1. A callback function or script can be provided such that the function or script is invoked once the condition arises.

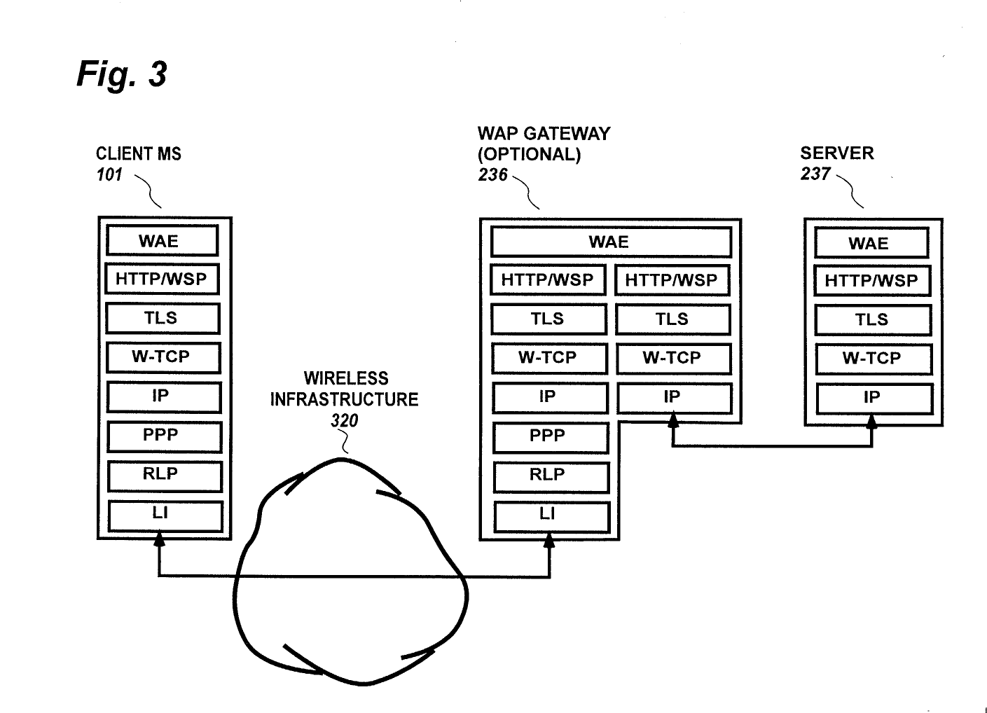

FIG. 3 shows the typical protocol architecture of the client mobile station 101, the WAP gateway 236, and the end server 237. The protocol layers include Wireless Application Environment (WAE), Hypertext transfer protocol (HTTP), Transport Layer Security (TLS), Wireless TCP (W-TCP), IP, Point-to-Point Protocol (PPP), Radio-Link Protocol (RLP), and Layer 1 (Physical Layer). PPP, RLP and L1 are used between mobile station and wireless infrastructure 320. The optional gateway converts the upper layer protocols from the wireless domain to the internet domain if necessary.

FIG. 4 further shows a mobile station 101 implementation consisting of: (a) an API 314 in the form of a set of functions, procedures or parameters; (b) a response generating component 316 that compiles the required information; and, (c) a condition detection component 318 that monitors location-related network conditions (including links to the call-processing or bearer service stack software to poll or request updates).

A generating component 316 within the mobile station takes network information and (i) selects the most appropriate information, i.e. that information that is most differentiating of the current location or conditions,(ii) eliminates redundant information, (iii) prioritizes the information elements and, (iv) compiles the network information response of the requested size containing the highest priority items.

The generating component 316 may keep its own database of the most recent network information. The monitoring component 318 may request from the call processing stack (layers 1 through 4) any updates of the information. The monitoring component 318 may receive updates from the stack on various network information items according to its requests. For example, it may receive updates on a specific time basis or degree of change depending on: (a) whether or not a location process is underway, and (b) the precision or accuracy requirements of the location-based activities.

For example, the call-processing entity may update the generating entity when a handoff occurs and a call or connection can be brought up only when necessary to inform the server of a location. Similarly, the generating entity may communicate the information, requested by a local application, and the local application may determine if it is necessary to update a server. In general, the bearer service component, collects dynamics information, CDMA physical layer details, link maintenance information as well as system level information from the CDMA stack.

The CDMA network information may be generated and cached for applications or scripts. The information may be cached in a variety of formats. The information may be cached in the mobile bearer service, WAP layers, scripts, or other local applications or services or on a server or network entity.

There may be varying levels of privacy and associated location items or precision to be reported. This can be accomplished by providing the user with options to select the desired degree of privacy in terms of which network items or set of network information to disclose. In addition an identified or key may be used to signify that the carrier or user have agreed to disclose the information to a script or remote server. This key is input to the generating entity.

If privacy is activated, the software must check that the user or carrier have enabled the release of network information to local or remote applications. There may be varying levels of privacy and associated location items or precision to be reported. This can be accomplished by providing the user with options to select the desired degree of privacy in terms of which network items or set of network information to disclose. In addition an identification or key may be used to signify that the carrier or user have agreed to disclose the information to a script or remote server. This key is input to the generating entity.

These combinations of privacy may be individually selected by the user or carrier to be turned on or off. An application may specify if it is local or remote or give an ID to the software in order to support verification of these items before releasing the location-sensitive information. The mobile station may release a varying degree of information depending on privacy level or accuracy level requested or permitted. For example, the mobile may release chip offsets at lower resolution if privacy is restricted to a certain point.

A sophisticated server can strategically formulate scripts, programs or requests to such a mobile station to enable a mobile station to perform location-based services. The server that receives the location information from the mobile can adaptively correlate non-GPS information such as dynamics information, CDMA physical layer details, link maintenance information and system level information to specific locations determined by GPS receivers and thus use non-GPS information to determine user locations. This is accomplished by correlating the non-GPS information that is received with the information stored in a database. The database contains the learned (adapted) information.

Consider the following example of an application: a server sends the mobile station a program or script that continuously checks if the mobile is at the desired location by monitoring the network information through the mobile station bearer service software. Once the mobile arrives at the desired location an alert is sent back to the server for tracking purposes. The invention provides a way to overcome inefficient polling by requesting a callback or update internally to the mobile station. The server can also translate a position represented as a (latitude, longitude) coordinate pair to a set of network information describing the same position. The mobile station can compare the provided network information with current network conditions. This allows the mobile to perform the location check without assistance from the server or network. The mobile station can alert a local or remote application once it has arrived and the position(s) described by the network information. The mobile can do this without any GPS technology or network assistance.

In IS-95 and cdma2000 based systems, the mobile station may only determine base station IDs from overheads. The overheads from a base station may only include that base station's ID. Therefore, mobile stations are not able to provide a server with base station IDs other than the serving cell. This problem can be overcome by storing BS IDs in the mobile station memory. The mobile can maintain a database of recent BS IDs cross references with PNs and SID/NIDs. Then, when making a location information update, the mobile can look up BS IDs in the database using PN, SID, NID for example, as the key.

The mobile station 101 can provide dynamics information in addition to static network information. The dynamics information includes previous SID, NID, channel, etc. so that the application or server can determine which direction the mobile station has been traveling in or where within the new cell the mobile is likely to be. There may be a greater likelihood that the mobile is between the current and previous cells than elsewhere in the new cell. Additionally, a TIME_CONSTANT field allows the mobile to inform the server of the time delay associated with the dynamics information. The server may thereby compute the average speed of travel of the mobile and perform predictions on future movement and future locations.

Since the mobile may supply derivatives of Ec/Io and Phase offsets, the server can compute the speed component of the mobile in the direction toward or away from each base station. Knowing the base station locations the server can compute the mobile's location more accurately. For example, the server can use an iterative Kalman filter to converge on the phase integer ambiguities rather than performing a search for those ambiguities based on a single snapshot of the phase measurements. General filtering and search methods are well known in the GPS field.

Although the present invention has been fully described in connection with the preferred embodiments thereof with reference to the accompanying drawings, it is to be noted that various changes and modifications will become apparent to those skilled in the art. Such changes and modifications are to be understood as being included within the scope of the present invention as defined by the appended claims.

What is claimed is:

1. A system for communicating information related to the position of a mobile station within a wireless communication infrastructure, comprising a data server capable of communicating with the wireless communication infrastructure, wherein the mobile station and the data server communicate via the wireless communication infrastructure using formatted messages representing wireless communication infrastructure state information related to the position of the mobile station within the service area of the wireless communication infrastructure.

2. The system of claim 1, wherein the formatted messages are short message service (SMS) messages.

3. The system of claim 1, wherein the wireless communication infrastructure uses code division multiple access.

4. The system of claim 1, wherein the mobile station is a cellular telephone.

5. The system of claim 1, wherein the mobile station is a PCS handset.

6. The system of claim 1, wherein the state information related to the position of the mobile station includes a base station identification and sector pseudo-noise offset.

7. The system of claim 1, wherein the state information is in the form of a standard string format.

8. The system of claim 7, wherein the more critical information is listed first in the string.

9. A wireless communication system comprising:
a data server;
a base station which communicates with the data server; and
a mobile station which communicates with the base station, the mobile station transmitting formatted messages to the base station for further communication to the data server, wherein the formatted message includes the mobile station position information.

10. The wireless communication system of claim 9, wherein the wireless communication system uses the code division multiple access format.

11. The wireless communication system of claim 9, wherein the formatted messages are short message service (SMS) messages.

12. The wireless communication system of claim 9, wherein the formatted messages are browser calls.

13. The wireless communication system of claim 9, wherein the mobile station communicates via the base station the formatted messages to an application or service on the data server.

14. The wireless communication system of claim 13, wherein the application or service on the data server is the Wireless Markup Language Script (WMLScript).

15. The wireless communication system of claim 14, wherein the communication to the Wireless Markup Language Script is via a Wireless Application Protocol Wireless Telephony Application Interface.

16. The wireless communication system of claim 9, wherein the formatted message is a text string.

17. The wireless communication system of claim 9, wherein the mobile station position information is derived from base station identification.

18. A method of communicating mobile station position information in a wireless communication system comprising:
determining the position information of the mobile station;
creating a formatted message including the position information; and
transmitting the formatted message to a data server via the wireless communication system.

19. The method of claim 18, further comprising detecting the base station identification information to determine the position information.

20. The method of claim 18, further comprising placing the more important information at the beginning of the formatted message.

21. The method of claim 18, further comprising communicating within the wireless communication system using code division multiple access standard.

22. The method of claim 18, further comprising forming the message in the short message service (SMS) format.

23. A mobile station for use in a wireless communication system comprising:
a position locator which defines the geographic position of the mobile station; and
a message formatter which creates a message containing the geographic position information of the mobile station.

24. The mobile station of claim 23, wherein the mobile station communicates the message to a base station.

25. The mobile station of claim 23, wherein the mobile station operates using the code division multiple access standard.

26. The mobile station of claim 23, wherein the message formatter creates a short message service (SMS) message.

27. The mobile station of claim 23, wherein the mobile station is a cellular handset.

28. The mobile station of claim 23, wherein the mobile station is a PCS handset.

29. A data server for use in a wireless communication system comprising:
means for communicating with a mobile station, wherein the data server receives a formatted message from the mobile station, the formatted message including information defining the position of the mobile station in the wireless communication system; and
applications which extract the position information from the formatted message.

30. The data server of claim 29, wherein the data server communicates with a base station.

31. The data server of claim 30, wherein the base station communicates with the mobile station.

32. The data server of claim 29, wherein the position information is used to determine appropriate data to transmit back to the mobile station.

33. The data server of claim 29, further comprising a network database correlated with position information.

34. The data server of claim 29, wherein the means for communicating uses the code division multiple access format.

35. A formatted message communicating position information of a mobile station in a wireless communication system comprising:
a header defining the information type;
a base station information field which includes information relating to the base station identification and active sector.

36. The formatted message of claim 35, wherein the message is a short message service (SMS) message.

37. The formatted message of claim 35, further comprising fields relating to previous base station identification.

38. The formatted message of claim 35, wherein the message includes information in the standard code division multiple access format.

39. A method of communicating a position of a mobile station in a wireless communication system comprising the steps of:
generating a message containing position information of the mobile station;
communicating the message via a wireless communication means; and
receiving the message at a data server.

40. The method of claim 39, further comprising detecting base station identification information to determine the position information.

41. The method of claim 39, further comprising formatting the message so the critical information is at the beginning of the formatted message.

42. The method of claim 39, further comprising the communication means using a code division multiple access standard.

43. The method of claim 39, further comprising forming the message in the short message service (SMS) format.

44. A system for communicating information related to the position of a mobile station comprising:
a mobile station capable of transmitting and receiving signals to and from a wireless communication infrastructure;
a wireless communication infrastructure that can transmit and receive signals to and from the mobile; and
a data server capable of communicating with said wireless communication infrastructure;
wherein said mobile station and said data server communicate via said wireless communication infrastructure using formatted messages representing current and past wireless communication state information related to said current and past positions of said mobile station.

45. The system of claim 44, wherein said wireless communication state information includes system identification.

46. The system of claim 44, wherein said wireless communication state information includes network identification.

47. The system of claim 44, wherein said wireless communication state information includes channel designation.

48. The system of claim 44, wherein said wireless communication state information includes sector status.

49. The system of claim 44, wherein said wireless communication state information includes received sector pilot channel energy.

50. The system of claim 49, wherein said received sector pilot channel energy is a ratio of pilot channel chip energy to total interference energy.

51. The system of claim 44, wherein said wireless communication state information includes the time offset of a received sector pilot channel.

52. The system of claim 44, further comprising a time interval value indicative of the time between measurements of said current and past wireless communication state information related to said mobile station's current and past positions.

53. The system of claim 44, wherein said mobile station includes a format generator, a bearer service stack monitor, and an application interface.

54. The system of claim 53, wherein said bearer service stack monitor stores base station information.

55. The system of claim 53, wherein said format generator formats messages so that the highest priority information is positioned near the beginning of the formatted message.

56. The system of claim 53, wherein said format generator selects information that is most differentiating of the current location of the mobile station.

57. The system of claim 53, wherein said format generator compiles the information of a requested size.

58. The system of claim 53, wherein said bearer service stack monitor detects location related wireless communication system states.

59. The system of claim 53, wherein said bearer service stack monitor detects location related wireless communication system state changes.

60. A system for communicating information related to the position of a mobile station comprising:
a mobile station capable of transmitting and receiving signals to and from a wireless communication infrastructure using code division multiple access techniques;
a wireless communication infrastructure that can transmit and receive signals to and from the mobile using code division multiple access techniques; and
a data server capable of communicating with said wireless communication infrastructure;
wherein said mobile station and said data server communicate via said wireless communication infrastructure using formatted messages representing wireless communication state information including the status of each pilot signal of a subset of the code division multiple access pilot signals known by said mobile station.

61. The system of claim 60, wherein the status of each pilot signal indicates in-use, desired, or undesired.

62. The system of claim 61, wherein said in-use status of a pilot signal as represented by said formatted message representing wireless communication state information indicates a pilot signal is within an active set of pilot signals.

63. The system of claim 61, wherein said desired status of a pilot signal as represented by said formatted message representing wireless communication state information indicates a pilot signal is within a candidate set of pilot signals.

64. The system of claim 61, wherein said desired status of a pilot signal as represented by said formatted message representing wireless communication state information indicates a pilot signal is within a neighbor set of pilot signals, wherein the pilot corresponds to a sector which is a candidate for future handoff by the mobile station.

65. The system of claim 61, wherein said undesired status of a pilot signal as represented by said formatted message representing communication infrastructure state information indicates a pilot signal is within a candidate set of pilot signals corresponding to sectors excluded from immediate consideration for hand-off by the mobile station.

66. The system of claim 60, wherein said wireless communication state information further comprises received sector pilot channel energy.

67. The system of claim 60, wherein said wireless communication state information further comprises an estimate of received signal power at the mobile station.

68. The system of claim 60, wherein said wireless communication state information further comprises the transmission power level of the mobile station.

69. The system of claim 60, wherein said wireless communication state information further comprises the signal channel currently being used by the mobile station.

70. The system of claim 60, wherein said wireless communication state information further comprises the system identification.

71. The system of claim 60, wherein said wireless communication state information further comprises the network identification.

72. The system of claim 60, wherein said wireless communication state information further comprises the user zone identification.

73. The system of claim 60, wherein said wireless communication state information further comprises the registration zone identification.

74. The system of claim 60, wherein said wireless communication state information further comprises a plurality of pseudo-noise offsets corresponding to said plurality of pilot signals.

75. A system for communicating information related to the position of a mobile station comprising:
a mobile station capable of transmitting and receiving signals to and from a wireless communication infrastructure using code division multiple access techniques;
a wireless communication infrastructure that can transmit and receive signals to and from the mobile using code division multiple access techniques; and
a data server capable of communicating with said wireless communication infrastructure;
wherein said mobile station and said data server communicate via said wireless communication infrastructure using formatted messages representing wireless communication infrastructure state information including the position of base stations monitored by said mobile station.

76. The system of claim 75, wherein said wireless communication state information further comprises received sector pilot channel energy.

77. The system of claim 75, wherein said wireless communication state information further comprises an estimate of received signal power at the mobile station.

78. The system of claim 75, wherein said wireless communication state information further comprises the transmission power level of the mobile station.

79. The system of claim 75, wherein said wireless communication state information further comprises the signal channel currently being used by the mobile station.

80. The system of claim 75, wherein said wireless communication state information further comprises the system identification.

81. The system of claim 75, wherein said wireless communication state information further comprises the network identification.

82. The system of claim 75, wherein said wireless communication state information further comprises the user zone identification.

83. The system of claim 75, wherein said wireless communication state information further comprises the registration zone identification.

84. The system of claim 75, wherein said wireless communication state information further comprises a plurality of pseudo-noise offsets corresponding to said plurality of pilot signals.

85. The system of claim 75, wherein said positions of each of said base stations is determined by monitoring transmissions of said base stations.

86. The system of claim 85, wherein said positions of each of said base stations is determined by monitoring of transmissions of said base stations, including information selected from a group of transmitted messages including: (i) system parameters message; (ii) neighbor list update message; (iii) handoff direction message.

87. The system of claim 85, wherein said positions of each of said base stations is determined by monitoring transmissions of said base stations, wherein said monitoring occurs when said mobile station is not engaged in a wireless call, and further wherein said information is stored within said mobile station for later use when said mobile station is engaged in a wireless call.

88. A method for communicating information related to the position of a mobile station comprising communicating between the mobile station and a data server via a wireless communication infrastructure using formatted messages representing current and past wireless communication state information related to current and past positions of the mobile station.

89. The method of claim 88, further comprising communicating wireless communication state information including system identification.

90. The method of claim 88, further comprising communicating wireless communication state information including network identification.

91. The method of claim 88, further comprising communicating wireless communication state information including channel designation.

92. The method of claim 88, further comprising communicating wireless communication state information including sector status.

93. The method of claim 88, further comprising communicating wireless communication state information including received sector pilot channel energy.

94. The method of claim 93, wherein said received sector pilot channel energy is a ratio of pilot channel chip energy to total interference energy.

95. The method of claim 88, further comprising communicating wireless communication state information including the time offset of a received sector pilot channel.

96. A method for communicating information related to the position of a mobile station comprising communicating using code division multiple access techniques between the mobile station and a data server via a wireless communication infrastructure using formatted messages representing wireless communication state information including the status of each pilot signal of a subset of the code division multiple access pilot signals known by said mobile station.

97. The method of claim 96, wherein the status of each pilot signal indicates in-use, desired, or undesired.

98. The method of claim 97, further comprising said in-use status of a pilot signal as represented by said formatted message representing wireless communication state information indicating a pilot signal is within an active set of pilot signals.

99. The method of claim 97, further comprising said desired status of a pilot signal as represented by said formatted message representing wireless communication state information indicating a pilot signal is within a candidate set of pilot signals.

100. The method of claim 97, further comprising said desired status of a pilot signal as represented by said formatted message representing wireless communication state information indicating a pilot signal is within a neighbor set of pilot signals, wherein the pilot corresponds to a sector which is a candidate for future handoff by the mobile station.

101. The method of claim 97, further comprising said undesired status of a pilot signal as represented by said formatted message representing communication infrastructure state information indicating a pilot signal is within a candidate set of pilot signals corresponding to sectors excluded from immediate consideration for hand-off by the mobile station.

102. A method for communicating information related to the position of a mobile station comprising communicating between the mobile station and a data server via a wireless communication infrastructure using formatted messages representing wireless communication infrastructure state information including the position of base stations monitored by said mobile station.

103. The method of claim 102, further comprising communicating wireless communication state information including received sector pilot channel energy.

104. The method of claim 102, further comprising communicating wireless communication state information including an estimate of received signal power at the mobile station.

105. The method of claim 102, further comprising communicating wireless communication state information including a transmission power level of the mobile station.

106. The method of claim 102, further comprising communicating wireless communication state information including the signal channel currently being used by the mobile station.

107. The method of claim 102, further comprising communicating wireless communication state information including a system identification.

108. The method of claim 102, further comprising communicating wireless communication state information including a network identification.

109. The method of claim 102, further comprising communicating wireless communication state information including a user zone identification.

110. The method of claim 102, further comprising communicating wireless communication state information including a registration zone identification.

111. A mobile station capable of transmitting and receiving signals to and from a data server via a wireless communication infrastructure, wherein the mobile station comprises a message formatter which generates formatted messages representing current and past wireless communication state information related to said current and past positions of said mobile station.

112. A mobile station capable of transmitting and receiving signals to and from a data server via a wireless communication infrastructure, wherein the mobile station comprises a message formatter which generates formatted messages representing wireless communication state information including the status of each pilot signal of a subset of the code division multiple access pilot signals known by said mobile station.

113. A mobile station capable of transmitting and receiving signals to and from a data server via a wireless communication infrastructure, wherein the mobile station comprises a message formatter which generates formatted messages representing wireless communication infrastructure state information including the position of base stations monitored by said mobile station.

114. A data server capable of transmitting and receiving signals to and from a mobile station via a wireless communication infrastructure, wherein the data server determines the position of the mobile station from formatted messages representing current and past wireless communication state information related to said current and past positions of said mobile station.

115. A data server capable of transmitting and receiving signals to and from a mobile station via a wireless communication infrastructure, wherein the data server determines the position of the mobile station from formatted messages representing wireless communication state information including the status of each pilot signal of a subset of the code division multiple access pilot signals known by said mobile station.

116. A data server capable of transmitting and receiving signals to and from a mobile station via a wireless communication infrastructure, wherein the data server determines the position of the mobile station from formatted messages representing wireless communication infrastructure state information including the position of base stations monitored by said mobile station.
